(19) United States
(12) Patent Application Publication
(10) Pub. No.: US 2026/0116711 A1
(43) Pub. Date: Apr. 30, 2026

(54) PINNING DEVICE FOR ASSEMBLING TWO STRUCTURAL ELEMENTS, IN PARTICULAR FOR A CRANE

(71) Applicant: Manitowoc Crane Group France, DARDILLY (FR)

(72) Inventors: Arnaud Avril, SAINT ETIENNE DES OUILLIERES (FR); Gabriel Fraisse, ANSE (FR); Philippe Peyron, SAINT NIZIER D'AZERGUES (FR)

(21) Appl. No.: 19/367,409

(22) Filed: Oct. 23, 2025

(30) Foreign Application Priority Data
Oct. 24, 2024 (FR) FR2411645

(51) Int. Cl. B66C 23/16; B66C 23/64

(52) U.S. Cl. CPC B66C 23/16; B66C 23/64

(57) ABSTRACT

A pinning device including a yoke including two facing plates, both having a through-orifice and delimiting a slot, two support elements fastened on the outer faces of the two plates around their through-orifices, and a pinning rod having two opposite ends and shaped to pass through the through-orifices and the two support elements. The pinning device being configurable in two standby configurations in which one of the two ends of the pinning rod is locked on one of the two support elements without the rod being engaged in the slot, and an assembly configuration in which the pinning rod is engaged in the slot and is locked on the two support elements.

### FIELD OF THE DISCLOSURE

The present disclosure relates to a pinning device for assembling a first structural element with a second structural element.

The present disclosure also relates to a pinning method implemented by means of the pinning device.

The present disclosure finds a preferred, and non-limiting, application for the assembly of two structural elements of a crane, and in particular of an element-assembled crane, a tower crane or an automated assembly crane, and in particular for the assembly of a rotating pivot and a jib holder of a tower crane.

### BACKGROUND

In a known manner, the cranes used on construction sites for buildings and civil engineering works comprise a mast at the top of which a rotating upper part is mounted, which can be oriented about a vertical axis, which comprises a jib and a counter-jib used as a counterweight support. The rotating upper part usually includes a rotating pivot surmounted by a jib holder. The jib and the counter-jib are assembled on either side of the jib holder.

One solution for assembling the jib holder on the rotating pivot is to use a pinning rod that passes right through a yoke (also called a stirrup) and a tenon forming a complementary assembly element mounted in the yoke. Conventionally, a yoke comprises two plates extending parallel to and facing each other, delimiting a slot to receive the tenon, and provided with through-orifices allowing the pinning rod to pass through.

However, the pinning rods are particularly heavy parts that can weigh more than 25 kilos (some rods can even weigh up to 80 kg), making them difficult to lift and carry by hand by one or several operators in charge of mounting and disassembling the crane, even if dedicated actuators are used to pull or push the pinning rod. The operations of engaging and removing the pinning rod are also not without risk for the operators.

Furthermore, the operators use tools such as hammers or hydraulic jacks in order to insert the pinning rod into the yoke and pass it through the through-orifices of the two plates. Depending on the dimensions of the through-orifices of the plates and of the pinning rod, friction may be exerted on the pinning rod and the through-orifices of the plates and damage them. In other words, the passage of the pinning rod inside the yoke leads to wear of the pinning rod and of the through-orifices of the plates.

There is therefore a constant need to implement in a simple and efficient manner (for example by limiting the number of actions that the operator must carry out), but also in a safe manner, an assembly and disassembly of a rotating pivot with a jib holder, and more broadly an assembly and disassembly of two structural elements.

### SUMMARY

To this end, in order to meet the needs previously formulated, the present disclosure proposes a pinning device for assembling a first structural element with a second structural element, said pinning device comprising:
a yoke intended to be secured to the first structural element, said yoke comprising two plates extending parallel to and facing each other and delimiting a slot for receiving a tenon secured to the second structural element, in which each of the two plates has an inner face delimiting the slot and an outer face opposite the inner face, and in which the two plates have respective through-orifices which are aligned;
two support elements which are fastened to the respective outer faces of the two plates around their respective through-orifices; and
a pinning rod extending longitudinally along a longitudinal axis and having a first end and a second end opposite each other, said pinning rod being shaped to pass through the through-orifices of the two plates and to pass through the two support elements;
said pinning device being configurable in:
a first standby configuration in which the first end of the pinning rod is carried and locked on one of the two support elements, called the first support element, without the pinning rod being engaged inside the slot;
an assembly configuration in which the pinning rod is engaged inside the slot passing through the two plates so that the first end of the pinning rod is carried and locked on the other of the two support elements, called the second support element, and the second end is carried and locked on the first support element;
a second standby configuration in which the second end of the pinning rod is carried and locked on the second support element, without the pinning rod being engaged inside the slot.

Hereinafter, and unless otherwise indicated, when it is indicated that the pinning device is in its first or second standby configuration, it is understood that the pinning rod is not engaged inside the slot of the yoke.

The pinning device is intended to switch to the assembly configuration from the first standby configuration following:
an unlocking of the first end on the first support element;
an axial movement of the pinning rod along a first direction of movement until the first end is engaged in the second support element and the second end is engaged in the first support element; and
a locking of the first end, respectively the second end, of the pinning rod on the second support element, respectively the first support element.

The pinning device is intended to switch into the second standby configuration from the assembly configuration following:
an unlocking of the first end, respectively the second end, of the pinning rod from the second support element, respectively the first support element;
an axial movement of the pinning rod along the same first direction of movement until the second end is engaged in the second support element (without the pinning rod being engaged in the slot); and
a locking of the second end of the pinning rod on the second support element.

In order to assemble the first structural element with the second structural element, the tenon secured to the second structural element must be mounted/inserted into the slot of the yoke before switching the pinning device from its first standby configuration to its assembly configuration.

When the first structural element and the second structural element are assembled, the disassembly of said first structural element and second structural element is made possible following: the switch of the pinning device from the assembly configuration to the second standby configuration; then the removal of the tenon secured to the second structural element from the yoke.

The pinning device is also intended to return to the first standby configuration from the second standby configuration following:
an unlocking of the second end of the pinning rod from the second support element;
an axial movement of the pinning rod along a second direction of movement, which is opposite the first direction of movement, until the first end is engaged in the first support element (without the pinning rod being engaged in the slot); and
a locking of the first end of the pinning rod on the first support element.

A first advantage of the pinning device is that it avoids the pinning rod needing to be lifted and manipulated by an operator or a lifting equipment, for example, in order to assemble or disassemble the two structural elements.

For example, following disassembly of the two structural elements, the pinning rod need not be removed from the pinning device. The pinning device may remain in its second standby configuration (with the cantilevered pinning rod locked on the second support element; or being repositioned in its assembly configuration so as to be locked on both support elements) or in its first standby configuration.

In other words, and advantageously, following disassembly, the pinning rod does not, for example, need to be removed, then carried, then placed by one or several operators, because it remains in place on one and/or the other of the two support elements.

In connection with this first advantage, the first structural element can be advantageously transported/routed with the pinning rod engaged in the pinning device in one of the three configurations. In other words, the pinning rod does not need to be transported by one or several operators using manual force.

Finally, an operator advantageously retains the possibility of disassembling, in other words removing, the pinning rod from the yoke, by unlocking, when the pinning device is configured in the first standby configuration (respectively in the second standby configuration), the pinning rod from the first support element (respectively from the second support element). An operator may wish to remove the pinning rod from the pinning device in order, for example, to apply an anti-corrosion treatment to it to limit its wear.

A second advantage of the pinning device is that the operator can perform assembly and disassembly, i.e., switching the pinning device from the first standby configuration to the assembly configuration and then from the assembly configuration to the second standby configuration, by axially moving the pinning rod along the same first direction of movement, as previously described.

Thus, an operator can advantageously use the same tool or actuator to axially move the pinning rod and cause the two configuration switches mentioned above.

Furthermore, given that the pinning device is configurable in two standby configurations (i.e., the first standby configuration and the second standby configuration) and that the transition from one to the other involves first switching the pinning device into its assembly configuration, the pinning rod can be engaged and then removed from one side of the yoke (i.e., the side of the first support element) as well as from the other side of the yoke (i.e., the side of the second support element).

In other words, advantageously, the pinning rod can be entered from the inside or the outside of the yoke, that is to say from one or other of the outer faces of the plates of the yoke.

Similarly, the pinning rod can be advantageously removed from the inside or the outside of the yoke, that is to say from one or other of the outer faces of the plates of the yoke.

For example, in a first application context, when the pinning device is in the first standby configuration, the operator, in order to assemble the first structural element with the second structural element, can position himself at the first support element and use, after unlocking the first end on the first support element, a mass or a hydraulic cylinder to axially push the pinning rod in order to engage it in the slot of the yoke and this until its first end reaches the second support element. Subsequently, in order to disassemble the two structural elements, the operator, after unlocking the two ends on the two support elements, can continue to use his mass or his hydraulic cylinder so as to axially move the pinning rod until its second end reaches the second support element (without the pinning rod being engaged in the slot).

In a second application context, the operator, in order to assemble the two structural elements, can position himself at the second support element and use, after unlocking the first end on the first support element, a come-along in order to pull the pinning rod towards it in order to engage it in the slot of the yoke and this until its first end reaches the second support element. In this second application context, the pinning rod can comprise a hooking member, such as a hook, intended to hook onto the come-along; such a hooking member can be mounted fixedly or removably on this pinning rod.

In order to return the pinning device to its first standby configuration from its second standby configuration, the operator can:
in the first context of use, position himself at the second support element and use his mass or his hydraulic cylinder to push the pinning rod axially until the first end reaches the first support element and without the pinning rod being engaged in the slot; or
in the second context of use, position himself at the first support element and use a come-along to pull the pinning rod towards him until the first end reaches the first support element and without the pinning rod being engaged in the slot.

In these two examples of context of use, the pinning rod is moved along a second direction of movement opposite the first direction of movement.

By offering the operator the possibility of switching the pinning device in each of its configurations by placing himself on only one side of it, and by avoiding him to manipulate the pinning rod itself as previously explained, the pinning device advantageously makes it possible to limit the movements of the operator and complex manipulations in risky areas, by confining them for example only to the locking/unlocking of the end(s) of the pinning rod during configuration switches. This is for example the case in the field of crane activity, where the operator is often required to carry out assemblies and disassemblies of structural elements while standing on platforms suspended above the void (which can be fastened to the mast or carried by lifting equipment).

Thus, the pinning device makes it possible to implement the assembly and disassembly of two structural elements in a simple, efficient and secure manner.

According to one embodiment of the present disclosure, the pinning device comprises a first pin removably mounted in a first radial hole provided on the first end of the pinning rod, and a second pin removably mounted in a second radial hole provided on the second end of the pinning rod, and each of the two support elements comprises two diametrically opposed openings capable of being crossed by the first pin or by the second pin, so that:
in the first standby configuration, the first pin passes through both the two openings of the first support element and the first radial hole, axially locking and limiting in rotation the pinning rod on the first support element;
in the assembly configuration, the first pin passes through both the two openings of the second support element and the first radial hole, and the second pin passes through both the two openings of the first support element and the second radial hole, axially locking and limiting in rotation the pinning rod on the first support element and on the second support element;
in the second standby configuration, the second pin passes through both the two openings of the second support element and the second radial hole, axially locking and limiting in rotation the pinning rod on the second support element.

Advantageously, the present disclosure implements a simple and efficient locking of the ends of the pinning rod on the support elements of the pinning device regardless of the configuration in which the latter is located; which locking on the pins removably mounted in the radial holes provided on the ends of the pinning rod, and the two diametrically opposite openings which comprise the two support elements and which are capable of being crossed by the pins.

When the pinning rod is locked on one of the support elements (in the standby configurations), or on both (in the assembly configuration), it is made impossible to move it axially, at least with the mounting clearance, and moreover it is limited in rotation, or even blocked in rotation depending on the conformation of the openings.

In other words, and advantageously, in the first standby configuration (respectively in the second standby configuration), the crossing of the first pin (respectively the second pin) both in the two openings of the first support element (respectively of the second support element) and the first radial hole (respectively the second radial hole) makes it possible to block in translation and limit in rotation the pinning rod inside the first support element (respectively the second support element). Consequently, the pinning rod cannot advantageously come out of the first support element (respectively of the second support element) in the first standby configuration (respectively in the second standby configuration).

Similarly, and advantageously, in the assembly configuration, the crossing of the first pin both in the two openings of the second support element and the first radial hole, and the crossing of the second pin both in the two openings of the first support element and the second radial hole, make it possible in the assembly configuration to block in translation and limit in rotation the pinning rod inside the first support element and the second support element. Consequently, the pinning rod cannot advantageously come out of the first support element and of the second support element when the pinning device is in its assembly configuration.

Since the pinning rod is blocked in translation and limited in rotation in the first support element and/or the second support element regardless of the configuration of the pinning device, and it is provided that the pinning rod is mounted in a fitted manner in the support elements, the friction between the pinning rod and the through-orifices of the plates of the yoke is advantageously significantly reduced. Consequently, the risks of wear of the pinning rod and of the plates at the through-orifices are significantly reduced.

In one embodiment, the first end of the pinning rod has the first radial hole and has another first radial hole also capable of being crossed by the first pin, and the second end of the pinning rod has the second radial hole and has another second radial hole also capable of being crossed by the second pin.

Depending on the means/tool used by an operator to axially move the pinning rod in the first direction of movement, or the second direction of movement, in order to switch the pinning device from one configuration to another, it is possible for the pinning rod to rotate on itself before being engaged in at least one of the first support element and of the second support element. By providing another radial hole on each of the ends of the pinning rod, it will be very likely that one or the other of the two radial holes will be opposite the corresponding openings to allow the passage of the corresponding pin

In one embodiment of the present disclosure, the first radial hole and the other first radial hole are perpendicular, and the second radial hole and the other second radial hole are perpendicular.

This configuration with two perpendicular radial holes is advantageous for ensuring that a radial hole faces the opening for mounting the concerned pin.

In one embodiment of the present disclosure, the two respective openings of the two support elements are oblong.

Such oblong openings provide advantageous angular displacement to ensure the facing of a radial hole with the opening for mounting the concerned pin.

According to one embodiment of the present disclosure, the two support elements are tubular in shape.

According to one embodiment of the present disclosure, the two support elements each have a collar fastened by screwing or bolting to the respective outer faces of the two plates.

According to one embodiment of the present disclosure, the pinning rod is cylindrical in shape and the two support elements have complementary bearings in which the pinning rod is mounted in a fitted manner with clearance in the assembly configuration.

The complementary bearings have a bearing diameter which is substantially greater than the diameter of the pinning rod (called rod diameter), that is to say that the pinning rod is mounted with a mounting clearance inside the complementary bearings so as to facilitate the insertion of the pinning rod into the support elements and to ensure the axial guidance thereof inside the through-orifices.

Thus, in addition to the locking, the complementary bearings advantageously contribute to maintaining/fastening the first end and the second end of the pinning rod respectively in the second support element and the first support element in the assembly configuration.

Also, the complementary bearings advantageously contribute to maintaining/fastening: the first end of the pinning rod in the first support element in the first standby configuration; and the second end of the pinning rod in the second support element in the second standby configuration.

The present disclosure also relates to an assembly comprising a first structural element and a second structural element assembled by means of a pinning device as previously described, in which the yoke is secured to the first structural element and the second structural element comprises a tenon inserted into the slot of the yoke and provided with an assembly orifice in alignment with the through-orifices of the two plates, and in which the pinning device is in its assembly configuration with the pinning rod which passes through said assembly orifice.

According to one embodiment, the first structural element and the second structural element correspond to structural elements of a crane.

In other words, the pinning device advantageously allows two structural elements of a crane to be assembled in a simple, efficient and secure manner.

According to one embodiment, one of the first structural element and of the second structural element corresponds to a rotating pivot, and the other of the first structural element and of the second structural element corresponds to a jib holder.

In other words, the pinning device advantageously allows, in a simple, efficient and secure manner, to assemble a rotating pivot and a jib holder of a crane.

The present disclosure finally relates to an assembly/disassembly method for assembling/disassembling a first structural element and a second structural element by means of a pinning device as described above, comprising the following steps:
before assembly, positioning the pinning device in its first standby configuration;
mounting a tenon, secured to the second structural element, in the slot of the yoke, said tenon being provided with an assembly orifice in alignment with the through-orifices of the two plates;
after having axially moved the pinning rod along a direction of movement, positioning the pinning device in its assembly configuration with the pinning rod which passes through said assembly orifice, so that the first structural element and the second structural element are assembled;
before disassembly, after having axially moved the pinning rod along the direction of movement, positioning the pinning device in the second standby configuration;
removing the tenon, secured to the second structural element, from the slot of the yoke so that the first structural element and the second structural element are disassembled.

The assembly/disassembly method therefore comprises steps for switching the pinning device from its first standby configuration to its assembly configuration, and from its assembly configuration to its second standby configuration. For switching and for positioning the pinning device in each of the configurations, the pinning method comprises steps of locking at least one of the two ends of the pinning rod for positioning in one of the three configurations, and steps of unlocking at least one of the two ends to allow the axial movement of the pinning rod.

In one embodiment, the assembly/disassembly method comprises, after the tenon removal step, and after an axial movement of the pinning rod along a second direction of movement opposite the (first) direction of movement, a step of positioning the pinning device in its first standby configuration.

### BRIEF DESCRIPTION OF THE DRAWINGS

Other features and advantages of the present disclosure will appear on reading the detailed description below, of a non-limiting example of implementation, made with reference to the appended figures in which:

FIG. 1 is a schematic view of a crane for which the pinning device of the present disclosure is used;

FIG. 2 shows two schematic perspective views of the pinning device when it is located/positioned in its first standby configuration, with the yoke of the pinning device secured to a first structural element corresponding to a pivoting mast of a crane;

FIG. 3 shows two schematic perspective views of the pinning device when it is located/positioned in its assembly configuration;

FIG. 4 shows a schematic perspective view of the pinning device when it is located/positioned in its second standby configuration;

FIG. 5 is a schematic side view of the pinning device in its first standby configuration, and for which is shown the insertion of a tenon into the slot of the yoke of the pinning device, which tenon is secured to a second structural element which corresponds to a jib holder;

FIG. 6 is a schematic side view of the pinning device in its assembly configuration, with the first structural element and the second structural element being assembled;

FIG. 7 is a schematic side view of the pinning device in its second standby configuration, with the tenon of the second structural element still inserted into the slot of the yoke of the pinning device.

### DETAILED DESCRIPTION

The pinning device 1 of the present disclosure is designed for the assembly and disassembly of a first structural element E1 with a second structural element E2. The design of the pinning device 1 presented below is given in an illustrative and non-limiting manner.

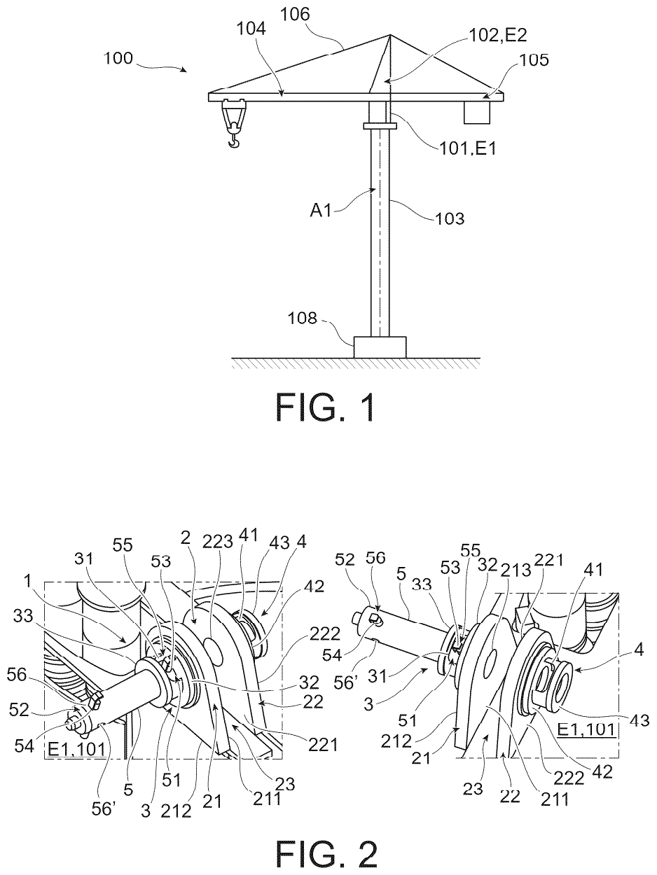

Also, the pinning device 1 is applicable in a plurality of fields of activity. In the remainder of the description, it is considered that the pinning device is used in the context of the mounting and disassembly of a crane 100, for example a crane 100 with a distributing jib as illustrated in FIG. 1. More precisely, the pinning device 1 is used for the assembly and disassembly of the rotating pivot 101, which corresponds to the first structural element E1, with the jib holder 102, which corresponds to the second structural element E2, of the crane 100.

Generally, the cranes comprise a mast 103 at the top of which a rotating upper part is mounted, orientable about a vertical axis A1, which comprises a jib 104 and a counter-jib 105 used as a support for counterweights and/or equipment such as winches. The rotating upper part usually includes a rotating pivot 101 surmounted by a jib holder 102 with tie rods 106. The jib 104 and the counter-jib 105 are assembled on either side of the jib holder 102. The crane operator's cabin 107 can be fastened to the rotating pivot 101 of the crane. The foot of the mast 103 can be disposed on a chassis 108 which can for example be fastened/placed on the ground, or even mounted on an undercarriage which comprises tracks or bogies.

With reference to FIGS. 2 to 4, the pinning device 1 comprises a pinning rod 5 extending longitudinally along a longitudinal axis and having a first end 51 and a second end 52 opposite each other. The pinning rod 5 may for example, and as illustrated in the various figures, be of cylindrical shape and have a rod diameter.

The pinning device also comprises a yoke 2 intended to be secured to the first structural element E1 (therefore to the rotating pivot 101), which comprises two plates 21, 22 which extend parallel to and facing each other and which delimit a slot 23 intended to receive a tenon 109 secured to the second structural element E2. Each of the two plates 21, 22 has: an inner face 211, 221 delimiting the slot 23 and an outer face 212, 222 opposite the inner face 211, 221, as well as a through-orifice 213, 223. The through-orifices 213, 223 of the plates 21, 22 are circular in shape and both have an orifice diameter. They are also formed in the two plates 21, 22 so as to be aligned.

The pinning device also comprises two support elements 3, 4 which each comprise a collar 32, 42 fastened, by screwing or bolting for example, on the respective outer faces 212, 222 of the two plates 21, 22. The two collars 32, 42 have an internal diameter substantially greater than the orifice diameter. The collars 32, 42 (and therefore the support elements 3, 4) are fastened to the respective outer faces 212, 222 of the two plates 21, 22 around their respective through-orifices 213, 223.

The pinning rod 5 is shaped to pass through the through-orifices 213, 223 of the two plates 21, 22 and to pass through the two support elements 3, 4. For this purpose, the rod diameter of the pinning rod 5 therefore corresponds to the orifice diameter of the through-orifices 213, 223.

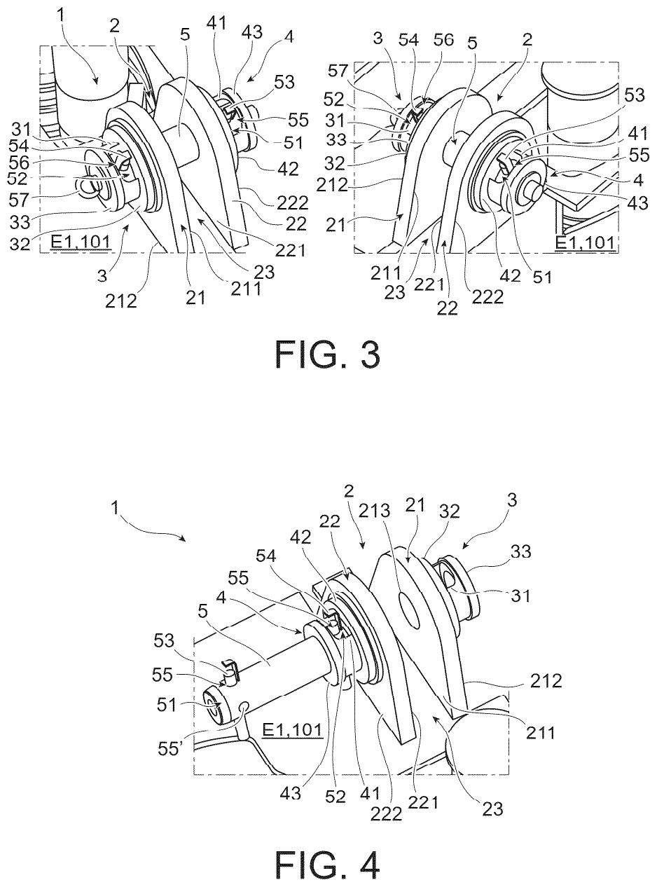

The pinning device 1 is configurable in:
a first standby configuration, illustrated in FIG. 2, in which the first end 51 of the pinning rod 5 is carried and locked on one of the two support elements 3, 4, called the first support element 3, without the pinning rod 5 being engaged inside the slot 23;
an assembly configuration, illustrated in FIG. 3, in which the pinning rod 5 is engaged inside the slot 23 while passing through the two plates 21, 22 such that the first end 51 of the pinning rod 5 is carried and locked onto the other of the two support elements 3, 4, called the second support element 4, and the second end 52 is carried and locked onto the first support element 3;
a second standby configuration, illustrated in FIG. 4, in which the second end 52 of the pinning rod 5 is carried and locked on the second support element 4, without the pinning rod 5 being engaged inside the slot 23.

In one embodiment, the support elements 3, 4 are designed to be removably mounted on the outer faces 212, 222 of the plates 21, 22; for example, so as to allow the yoke 2 to be treated against corrosion when the support elements 3, 4 are removed.

Referring to the same three FIGS. 2 to 4, a first radial hole 55 and a second radial hole 56 are drilled respectively at the first end 51 and the second end of the pinning rod 5. The first radial hole 55 and the second radial hole 56 are drilled along a drilling axis which is perpendicular to the longitudinal axis of the pinning rod 5.

The first radial hole 55 and the second radial hole 56 are provided to be respectively crossed by a first pin 53 and a second pin 54 which can be removably mounted on the pinning rod 5. Each of the two support elements 3, 4 comprises two diametrically opposed openings 31, 41. The openings 31, 41 are arranged such that once the first end 51 or the second end 52 is engaged in the first support element 3 or the second support element 4, the openings 31, 41 make the first radial hole 55 and/or the second radial hole 56 accessible to an operator; which can then pass the first pin 53 and the second pin 54 through the openings 31, 41 and the radial holes 55, 56 of the ends of the pinning rod 5, then subsequently lock the latter on one or both support elements 3, 4 using one or both pins 53, 54.

Thus, in the first standby configuration, the first pin 53 passes through both the two openings 31 of the first support element 3 and the first radial hole 55, thus axially locking the pinning rod 5 on the first support element 3.

In the assembly configuration, the first pin 53 passes through both the two openings 41 of the second support element 4 and the first radial hole 55, and the second pin 52 passes through both the two openings 31 of the first support element 3 and the second radial hole 56, thus axially locking the pinning rod 5 on the first support element 3 and on the second support element 4.

Finally, in the second standby configuration, the second pin 52 passes through both the two openings 41 of the second support element 4 and the second radial hole 56, thus axially locking the pinning rod 5 on the second support element 4.

Depending on the means/tool used by an operator to axially move the pinning rod 5 in the first direction of movement, or the second direction of movement, in order to switch the pinning device 1 from one configuration to another, it is possible for the pinning rod 5 to rotate on itself before being engaged in at least one of the first support element 3 and the second support element 4. In the case where the first end 51 and the second end 52 respectively comprise only one radial hole 55 and a second radial hole 56, it is possible for the at least one of the first radial hole 55 and the second radial hole 56 not to be aligned (that is to say facing) with the openings 31, 41 of the at least one of the first support element 3 and the second support element 4, not allowing the mounting of the at least one of the first pin 53 and the second pin 54.

In one embodiment, and as illustrated in FIGS. 2 to 4, it is possible to drill a radial hole 55 and another first radial hole 55′ at the first end 51 of the pinning rod 5; and a second radial hole 56 and another second radial hole 56′ at the second end 52 of the pinning rod 5. It will then be very likely that one or the other of the two radial holes 55, 55′, 56, 56′ will be opposite the corresponding openings 31, 41 to allow the passage of the corresponding pin 53, 54.

According to one example, it is conceivable that the first radial hole 55 is perpendicular to the other first radial hole 55′, and that the second radial hole 56 is perpendicular to the other second radial hole 56′. This configuration with two perpendicular radial holes 55, 55′, 56, 56′ is advantageous for ensuring that a radial hole 55, 55′, 56, 56′ is opposite a light 31, 41 for mounting the concerned pin 53, 54.

To ensure the alignment of a radial hole 55, 55′, 56, 56′ with each of the openings 31, 41 for the mounting of the concerned pin 53, 54, the two openings 31, 41 can for example have an oblong shape.

When the pinning rod 5 is locked onto one or both of the support elements 3, 4, it is made impossible to move it axially. The pinning rod 5 is also limited in rotation within the two support elements 3, 4. For example, as illustrated in FIGS. 2 to 4, the first pin 53 and the second pin 54 both have a length such that once one and/or the other is inserted into the first radial hole 55 and the second radial hole 56, it or they come into abutment against the openings 31, 41 of the first support element 3 and/or the second support element 4 when an operator attempts to move the pinning rod 5 axially.

In other words, and advantageously, in the first standby configuration (respectively in the second standby configuration), the crossing of the first pin 53 (respectively the second pin 54) both in the openings 31, 41 of the first support element 3 (respectively of the second support element 4) and the first radial hole 55 (respectively the second radial hole 56) makes it possible to block in translation and limit in rotation the pinning rod 5 inside the first support element 3 (respectively the second support element 4). Consequently, the pinning rod 5 cannot advantageously come out of the first support element 3 (respectively of the second support element 4) in the first standby configuration (respectively in the second standby configuration).

Similarly, and advantageously, in the assembly configuration, the crossing of the first pin 53 both in the openings 41 of the second support element 4 and the first radial hole 55, and the crossing of the second pin 54 both in the openings 31 of the first support element 3 and the second radial hole 56, make it possible in the assembly configuration to block in translation and limit in rotation the pinning rod 5 inside the first support element 3 and the second support element 4. Consequently, the pinning rod 5 cannot advantageously come out of the first support element 3 and the second support element 4 when the pinning device 1 is in its assembly configuration).

In order for the pinning rod 5 (more precisely its two ends 51, 52) to be fitted in a fitted manner in the pinning device 1 in each of its configurations, the first support element 3 and the second support element 4 may both comprise a complementary bearing 33, 43 in which the pinning rod 5 can be engaged.

The complementary bearings 33, 43 have a bearing diameter which is substantially greater than the rod diameter of the pinning rod 5, that is to say the pinning rod 5 is mounted with a mounting clearance inside the complementary bearings 33, 34, so as to facilitate the insertion of the pinning rod 5 into the support elements 3, 4 and to ensure the axial guidance thereof inside the through-orifices 213, 223.

Since the pinning rod 5 is blocked in translation and limited in rotation in the first support element 3 and/or the second support element 4 regardless of the configuration of the pinning device 1, and since it is mounted in a fitted manner in the support elements 3, 4, the friction between the pinning rod 5 and the through-orifices 213, 223 of the plates 21, 22 of the yoke 2 is advantageously significantly reduced. Consequently, the risks of wear of the pinning rod 5 and the plates 21, 22 at the through-orifices 213, 223 are significantly reduced.

When the pinning device 1 is in its first standby configuration, it is designed to switch into its assembly configuration following:
an unlocking and a removal of the first pin 53, leading to unlocking of the first end 51 on the first support element 3;
an axial movement of the pinning rod 5 in a first direction of movement until the first end 51 is engaged in the second support element 4 and the second end 52 is engaged in the first support element 3;
an insertion of the first pin 53 (respectively of the second pin 54) into the first radial hole 55 (respectively the second radial hole 56); and
a locking of the first pin 53 (respectively of the second pin 54) on the first end 51 (respectively the second end 52), then leading to a locking of the first end 51 (respectively the second end 52) on the second support element 4 (respectively the first support element 3).

The pinning device 1 is also provided to switch from the assembly configuration to the second standby configuration following:
an unlocking and a removal of the first pin 53 and the second pin 54, leading to an unlocking of the first end 51 and the second end 2 respectively on the second support element 4 and first support element 3;
an axial movement of the pinning rod 5 in the first direction of movement until the second end 52 is engaged in the second support element 4 (without the pinning rod 5 being engaged in the slot 23); and
a locking of the second pin 54 on the second end 52, then leading to a locking of the second end 52 on the second support element 4.

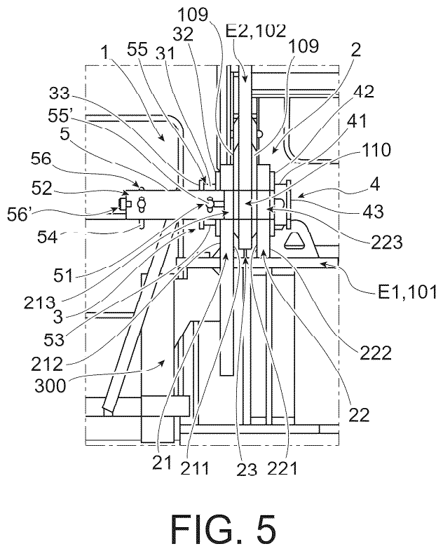

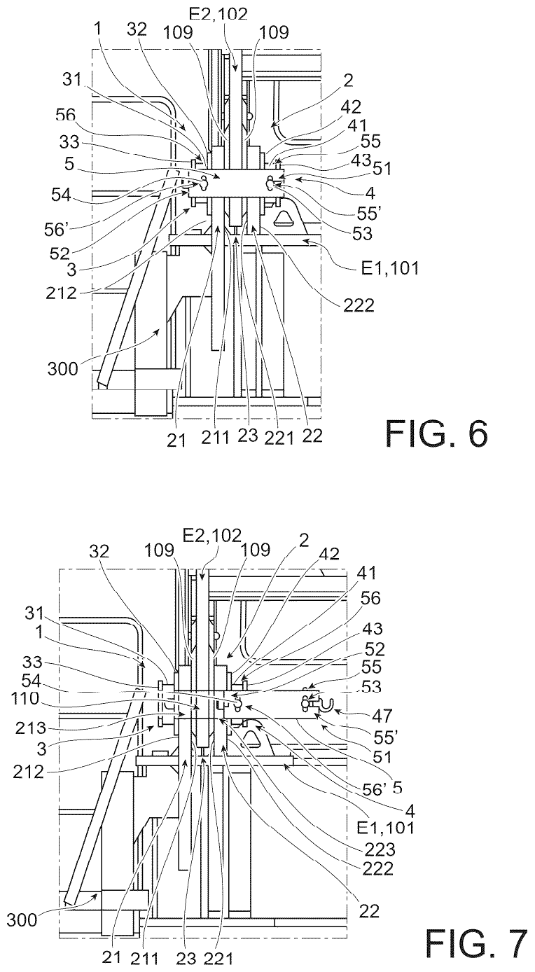

With reference to FIGS. 5 to 7, in order to assemble the first structural element E1 (i.e., the rotating pivot 101) with the second structural element E2 (i.e., the jib holder 102), the tenon 109 secured to the second structural element E2 is first inserted into the slot 23 of the yoke 2 when the pinning device 1 is in its first standby configuration. The tenon 109 has an assembly orifice 100 of at least the same diameter as the through-orifices 213, 223 and the rod diameter of the pinning rod 5. The tenon 109 is inserted into the slot 23 so that its assembly orifice 110 is aligned with the through-orifices 213, 223.

The switching of the pinning device 1 from its first standby configuration to its assembly configuration is then implemented. The pinning rod 5, during its axial movement in the first direction of movement, passes through the through-orifices 213, 223 of the plates 21, 22 of the yoke 2 as well as the assembly orifice 110 of the tenon 109. The first structural element E1 is assembled with the second structural element E2 once the pinning device 1 is positioned in its assembly configuration, with the first end 51 and the second end 52 of the pinning rod 5 respectively locked on the second support element 4 and the first support element 3.

In order to disassemble the first structural element E1 with the second structural element E2, the switching of the pinning device 1 from its assembly configuration to its second standby configuration is implemented. Once the pinning device 1 is positioned in its second assembly configuration, and since the second end 52 of the pinning rod is not engaged in the slot 23 and consequently in the assembly orifice 110 of the tenon 109, the tenon 109 can be removed from the slot 23.

After disassembly, the pinning device 1 is intended to return to its first standby configuration from its second standby configuration. For this, the second end 52 is unlocked from the second support element, then an axial movement of the pinning rod 5 is implemented in a second direction of movement, which is opposite to the first direction of movement, until the first end 51 of the pinning rod 5 is housed in the first support element 3, without the pinning rod being engaged in the slot 23. Finally, the first end 51 of the pinning rod 5 is locked in the first support element 3, the pinning device 1 then being positioned in its first standby configuration.

Since the pinning device 1 can return to its first standby configuration from its second standby configuration, it is able to switch from its second standby configuration to its assembly configuration, and then from its assembly configuration to its first standby configuration.

Whatever the configuration in which the pinning device 1 is positioned, at least one of the two ends 51, 52 of the pinning rod 5 is carried and locked in at least one of the two support elements 3, 4.

Thus, and advantageously, an operator does not have to manipulate the pinning rod 5 itself during the assembly or disassembly of the rotating pivot 101 and the jib holder, and more generally between the first structural element E1 and the second structural element E2.

In other words, and advantageously, when assembling or disassembling the rotating pivot 101 and the jib holder, an operator is not required to lift the pinning rod 5, carry it by arm strength, place it, etc.

Generally, to assemble a rotating pivot 101 with a jib holder 12, the operator(s) stand, or even move, on suspended platforms 300 which may, for example: be fastened to the rotating pivot 101 (as illustrated in FIGS. 5 to 7); or held, raised and lowered by lifting equipment. Depending on the steps enabling the assembly and disassembly of these two crane elements 100, the operator(s) may be required to use a plurality of tools and/or actuators, or have to move on the platform 300 to carry out risky manipulations which compromise their safety.

Advantageously, the switching of the pinning device 1 from its first standby configuration to its assembly configuration, and from its assembly configuration to its second standby configuration, with axial movement of the pinning rod 5 in the same first direction of movement, makes it possible to limit: the number of risky manipulations, the movements of an operator on a platform 300, and the number of tools or actuators to be used for an assembly or disassembly.

Given that the pinning device 1 is configurable in two standby configurations (i.e., the first standby configuration and the second standby configuration) and that the passage from one to the other involves a prior switching of the pinning device 1 into its assembly configuration, the pinning rod 5 can be engaged then removed from one side of the yoke 2 (i.e., on the side of the first support element 3) as well as from the other side of the yoke 2 (i.e., on the side of the second support element 4).

In other words, advantageously, the pinning rod 5 can be entered from the inside or the outside of the yoke 2, that is to say from one or the other of the outer faces 212, 222 of the plates 21, 22 of the yoke 2.

Similarly, the pinning rod 5 can advantageously be removed from the inside or the outside of the yoke 2, that is to say from one or other of the outer faces 212, 222 of the plates 21, 22 of the yoke 2.

With reference to FIG. 5 to FIG. 7, in the case where a platform 300 is fastened to the rotating pivot 101, an operator can for example position himself at the first support element 3 and use an actuator, for example a hydraulic cylinder, to push axially in the first direction of movement the pinning rod 5 during the switching of the pinning device 1 between its first standby configuration and its assembly configuration, and between its assembly configuration and its second standby configuration. He can also, when the pinning rod 5 is of cylindrical shape as in the context of this description, use for example a mass to tap on the base of the pinning rod 5 located at the second end 52.

Conversely, to implement these two switching operations, the operator can also, for example, position himself at the level of the second support element 4, and slide into the through-orifices 213, 223 a pull-rod which will be hooked onto a hooking member 47, for example a hook, which the pinning rod 5 comprises, then allowing him to pull the pinning rod 5 axially in the first direction of movement. Thus, in this application context, the movements of the operator on the platform can be limited to the insertion into the radial holes 55, 56 then to the locking, or to the unlocking then to the removal from the radial holes 55, 56, of the first pin 53 and/or the second pin 54.

The pinning device 1 of the present disclosure therefore makes it possible to implement in a simple, efficient and secure manner the assembly and disassembly of a rotating pivot 101 and a jib holder 102, or more generally of a first structural element E1 with a second structural element E2.

Although the present disclosure has been described with reference to specific embodiments, it is obvious that modifications and changes may be made to these examples without departing from the general scope of the present disclosure as defined by the claims. In particular, individual features of the various illustrated/mentioned embodiments may be combined in additional embodiments. Therefore, the description and drawings should be considered in an illustrative rather than restrictive sense.

It is also obvious that all the features described with reference to a method are transposable, alone or in combination, to a device, and conversely, all the features described with reference to a device are transposable, alone or in combination, to a method.

1. A pinning device for assembling a first structural element with a second structural element, said pinning device comprising:
a yoke intended to be secured to the first structural element, said yoke comprising two plates extending parallel to one another and delimiting a slot for receiving a tenon secured to the second structural element, in which each of the two plates has an inner face delimiting the slot and an outer face opposite the inner face, and in which the two plates have respective through-orifices which are aligned;
two support elements, wherein the two support elements include a first support element and a second support element which are fastened on the respective outer faces of the two plates around their respective through-orifices; and
a pinning rod extending longitudinally along a longitudinal axis and having a first end and a second end opposite each other, said pinning rod being shaped to pass through the through-orifices of the two plates and to pass through the two support elements;
said pinning device being configurable in:
a first standby configuration in which the first end of the pinning rod is carried and locked on the first support element, without the pinning rod-being engaged inside the slot;
an assembly configuration in which the pinning rod is engaged inside the slot by passing through the two plates so that the first end of the pinning rod is carried and locked on the second support element, and the second end is carried and locked on the first support element; and
a second standby configuration in which the second end of the pinning rod is carried and locked on the second support element, without the pinning rod being engaged inside the slot.

2. The pinning device according to claim 1, comprising a first pin removably mounted in a first radial hole provided on the first end of the pinning rod, and a second pin removably mounted in a second radial hole provided on the second end of the pinning rod, and each of the two support elements comprises two diametrically opposed openings capable of being crossed by the first pin or by the second pin, so that:
in the first standby configuration, the first pin passes through both the two openings of the first support element and the first radial hole, axially locking and limiting in rotation the pinning rod on the first support element;
in the assembly configuration, the first pin passes through both the two openings of the second support element and the first radial hole, and the second pin passes through both the two openings of the first support element and the second radial hole, axially locking and limiting in rotation the pinning rod on the first support element and on the second support element; and
in the second standby configuration, the second pin passes through both the two openings of the second support element and the second radial hole, axially locking and limiting in rotation the pinning rod on the second support element.

3. The pinning device according to claim 2, wherein the first end of the pinning rod has the first radial hole and has another first radial hole also capable of being crossed by the first pin, and the second end of the pinning rod has the second radial hole and has another second radial hole also capable of being crossed by the second pin.

4. The pinning device according to claim 3, wherein the first radial hole and the other first radial hole are perpendicular, and the second radial hole and the other second radial hole are perpendicular.

5. The pinning device according to claim 2, wherein the two respective openings of the two support elements are oblong.

6. The pinning device according to claim 1, wherein the two support elements are tubular in shape.

7. The pinning device according to claim 1, wherein the two support elements each have a collar fastened by screwing or bolting on the respective outer faces of the two plates.

8. The pinning device according to claim 1, wherein the pinning rod is cylindrical in shape and the two support elements have complementary bearings in which the pinning rod is fitted in a fitted manner with clearance in the assembly configuration.

9. An assembly comprising a first structural element and a second structural element assembled by means of a pinning device according to claim 1, in which the yoke is secured to the first structural element and the second structural element-comprises a tenon inserted in the slot of the yoke and provided with an assembly orifice in alignment with the through-orifices of the two plates, and in which the pinning device is in its assembly configuration with the pinning rod-which passes through said assembly orifice.

10. The assembly according to claim 9, wherein the first structural element and the second structural element correspond to structural elements of a crane.

11. The assembly according to claim 10, wherein one of the first structural element and the second structural element corresponds to a rotating pivot, and the other of the first structural element and the second structural element corresponds to a jib holder.

12. An assembly/disassembly method for assembling/disassembling a first structural element and a second structural element with a pinning device according to claim 1, the method comprising:
before assembly, positioning the pinning device in its first standby configuration;
mounting a tenon, secured to the second structural element, in the slot of the yoke, said tenon being provided with an assembly orifice in alignment with the through-orifices of the two plates;
after having axially moved the pinning rod in a direction of movement, positioning the pinning device in its assembly configuration with the pinning rod passing through said assembly orifice, so that the first structural element and the second structural element are assembled;
before disassembly, after having axially moved the pinning rod in the direction of movement, positioning the pinning device in the second standby configuration; and
removing the tenon, secured to the second structural element, from the slot of the yoke so that the first structural element and the second structural element are disassembled.
